(19) United States
(12) Patent Application Publication
(10) Pub. No.: US 2008/0294866 A1
(43) Pub. Date: Nov. 27, 2008

(54) Method And Apparatus For Memory Management

(75) Inventors: Sudheer KURICHIYATH, Bangalore (IN); Anjali Anant Kanak, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 12/124,806

(22) Filed: May 21, 2008

(30) Foreign Application Priority Data
May 22, 2007 (IN) 1070/CHE/2007

(51) Int. Cl. G06F 12/00

(52) U.S. Cl. 711/201; 711/E12.001

(57) ABSTRACT

An apparatus and a method for managing a memory are presented. In one example embodiment, the method and the apparatus includes a memory that has one or more partitions. Each of the partitions includes one or more zones. Each of the zones includes one or more memory ranges. In this example embodiment, the method begins by determining occurrence of memory shortage in a first partition of the memory during runtime of the apparatus. Based on the outcome of the determination, during runtime of the apparatus, the memory from the one or more zones of the one or more partitions of the memory is claimed by instantiating invocation of memory claiming process.

### RELATED APPLICATIONS

This patent application claims priority to an Indian patent application having serial no. 1070/CHE/2007, having title “Method and Apparatus for Memory Management”, which was filed on 22 May 2007 in India (IN), which is commonly assigned herewith, and which is hereby incorporated by reference.

### BACKGROUND

New generation information systems include one or more processors and at least a memory. The memory may be used by the processors while they are in operation. These systems generally may be partitioned logically or virtually or physically or any combination thereof. The partitioned systems may include memory, which may have one or more memory ranges. A memory range may be a set of memory pages. A group of memory ranges is also be referred as a zone or a slab. The zone or the slab represents a contiguous piece of memory, usually made of at least one physically contiguous page or memory range. These systems are also capable of running a plurality of Operating Systems (OSs or OS). Each of the OSs may host its own set of applications on the memory. The systems may allow transfer of memory range/s from one partition to another partition.

Generally, migration (or configuration/reconfiguration) of memory range from one partition to another partition is performed either manually or through detecting applications, such as a hypervisor. When an OS desires memory, it instantiates process for claiming memory from different zones of the memory. Such memory claiming process is generally referred to as garbage collection process. During the memory claiming process the OS initiates a paging daemon to contact a garbage collector of each zone to obtain information of the unused memory ranges.

These approaches may require reserved memory ranges to facilitate migration of the memory ranges.

### BRIEF DESCRIPTION OF DRAWINGS

Embodiments of the invention will now be described, by way of example only, with reference to the accompanying drawings in which:

FIG. 1 shows an apparatus for managing memory according to an embodiment of the present subject matter;

FIG. 2 shows a method of memory management in accordance with an embodiment of the present subject matter;

FIG. 3 shows in more detail the step of instantiating invocation of memory claiming process according an embodiment of the present subject matter; and

FIG. 4 shows an example of a suitable computing system environment for implementing embodiments of the present subject matter, such as those shown in FIGS. 1-3.

### DETAIL DESCRIPTION OF DRAWINGS

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

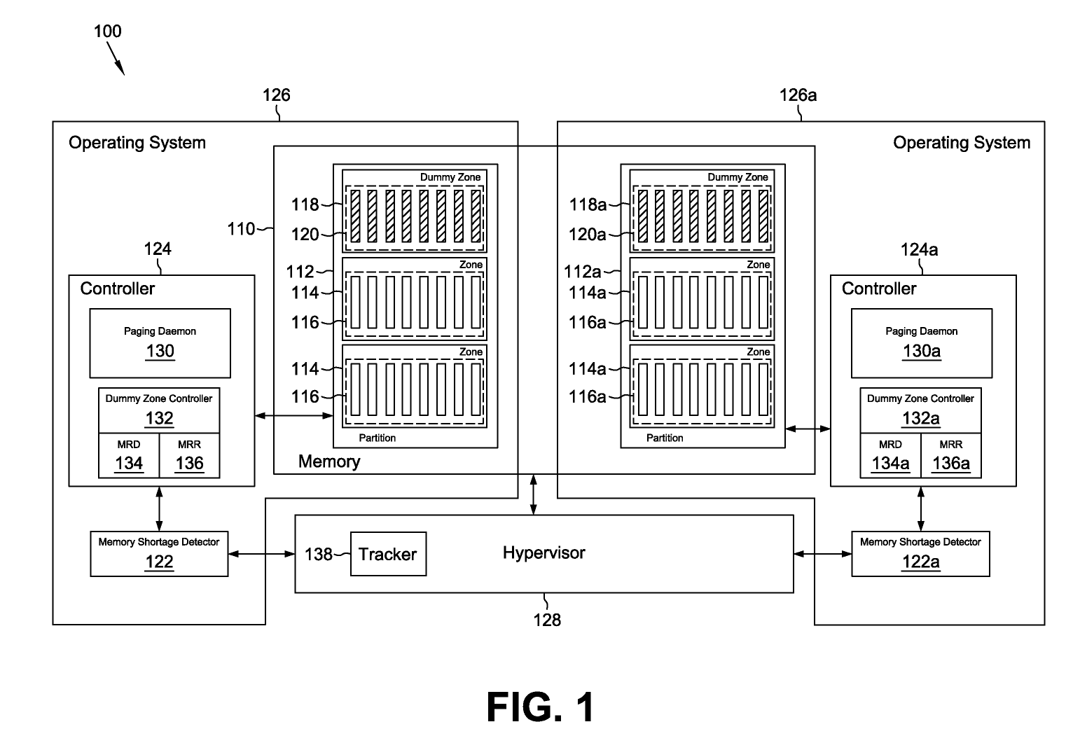

FIG. 1 shows an apparatus 100 for managing memory in accordance with an embodiment of the present subject matter. The apparatus 100 includes a memory 110. The memory 110 may have one or partitions 112 and 112a. The partitions 112 and 112a may be initialized by one or more OSs 126 and 126a. The apparatus 100 may include a hypervisor 128. The hypervisor 128 may include a tracker 138. The partition 112 may have a number of zones 114. Each of the zones 114 may include a number of memory ranges 116. The partitions 112 may include at least one dummy zone 118. The dummy zone 118 may include claimable memory ranges 120. In an embodiment, the dummy zone 118 may virtually include the memory ranges that may be claimed from other partitions of the memory 110. The OS 126 may include a controller 124 and a memory shortage detector 122. The controller 124 may include a paging daemon 130 and a dummy zone controller 132. The dummy zone controller 132 may include a Memory Range Receiver (MRR) 136 and a Memory Range Dispatcher (MRD) 134.

Similarly, the partition 112a may have a number of zones 114a. Each of the zones 114a may include a number of memory ranges 116a. The partitions 112a may include at least one dummy zone 118a. The dummy zone 118a may include claimable memory ranges 120a. In an embodiment the dummy zone 118a may virtually include the memory ranges may be claimed from other partitions of the memory 110. The OS 126a may include a controller 124a and a memory shortage detector 122a. The controller 124a may include a paging daemon 130a and a dummy zone controller 132a. The dummy zone controller 132a may include an MRR 136a and an MRD 134a. The inclusion of dummy zones 118 and 118a offers opportunity to the respective OS to instantiate claiming of memory ranges from the memory ranges included in the dummy zones and reducing the vulnerability of the OSs to run into system thrashing as the memory ranges of the dummy zones 118 and 118a may be claimed by any of the partitions of the memory 110. At the same time, no memory ranges are required to be kept reserved for migrations (transfer) of the memory ranges in any partition.

As shown in FIG. 1, the apparatus 100 includes two OSs 126 and 126a. The two OSs 126 and 126a may be substantially same in terms of their constituents. Following this fact, in the foregoing discussion, for the purpose of explanation, brevity and clarity the constituents and operation of the OS 126 are being explained. Similar explanation is possible for the OS 126a with appropriate substitution of the constituents. Also, for having a better understanding of the subject matter the partition 112 may be considered as a first partition, which is running into a shortage of memory, and the partition 112a may be considered as a second partition, which may transfer memory ranges to the first partition. Further, it should be understood that the FIG. 1 and the associated explanation describes the present subject matter with reference two OSs 126 and 126a and two partitions 112 and 112a, respectively, however the implementation of the present subject matter is not limited to such restrictions.

The apparatus 100 may be configured for generating the dummy zone 118 in the partition 112 of the memory 110 during initialization of the apparatus 100. During initialization, the apparatus 100 may identify memory ranges 120 that are ejectable from the partition 112 and/or claimable from any other partition 112a. The identified memory ranges 120 may form the dummy zone 118. According to one embodiment, the paging daemon 130 may be configured for identifying unused memory ranges 116 from the zone 114. The paging daemon 130 may include the identified memory ranges 116 in the dummy zone 118. The memory ranges 120 of the dummy zone are the memory ranges that may be transferred to, or claimed by the other partitions 112a, or ejected from the partition 112, or used by the zone 114.

The memory shortage detector 122 may be configured for detecting occurrence of memory shortage in the partition 112 of the memory 110 during run time of the apparatus 100. The memory shortage detector 122 may configured for detecting invocation of a memory claiming process for claiming unused memory ranges of the partition 112 during the runtime of the apparatus 100. Upon detecting such an invocation the memory shortage detector may conclude that the OS 126 is running under memory shortage. The controller 124 may be configured for instantiating process for claiming memory from the one or more zones 114 and 114a of one or more partitions 112 and 112a of the memory 110 according to the outcome of the memory shortage detector 122. The memory shortage detector 122 may be any detector that is capable of detecting invocation of a memory claiming process for claiming unused memory ranges of the partition 112 during the runtime of the apparatus 100.

In these embodiments, whenever the apparatus 100 or the OS 126 suffers a memory shortage, the apparatus 100 or the OS 126 invokes a memory claiming process for claiming unused memory ranges 116 of the partition 112. The memory shortage detector 122 detects such invocation. The detection by the memory shortage detector 122 is an indication of memory shortage observed by the OS 126 or the apparatus 100. Upon detecting such a shortage, the controller 124 of the OS 126 may instantiate a memory claiming process for claiming memory from the other partitions 112a.

The controller 124 may initiate the memory claiming process by instructing the dummy zone controller 132 to commence memory claiming process. The dummy zone controller 132 may commence the memory claiming process using the MRR 136. The MRR 136 may issue instructions to the hypervisor 128 to obtain details of the available memory ranges 116a and 120a in the partition 112a. While issuing instructions the MRR 136 may also provide an estimate of required number of memory ranges (size of required memory) to the hypervisor 128.

On receipt of above instruction the hypervisor 128 may refer to a register that may be maintained in the tracker 138 to provide desired information or may obtain desired details from the MRD 134a of the dummy zone controller 132a. While obtaining details from the MRD 134a, the hypervisor 128 may provide an estimate of required number of memory ranges (size of required memory) to the MRD 134a. The MRD 134a may dispatch details of available claimable memory ranges 116a and 120a to the hypervisor 128.

While dispatching the details to the hypervisor 128, the MRD 134a confirms that transfer of the memory ranges 116a and/or 120a would not result in a memory shortage in the partition 112a. For confirming above the dummy zone controller 132a may instantiate detecting of occurrence memory shortage in the partition 112a due to the transferring of the memory ranges 116a and/120a of the partition 112a. The dummy zone controller 132a may confirm above by comparing the number of memory ranges (size of the required memory) that are desired to be transferred and the number of available claimable memory ranges (size of the available claimable memory ranges) in the partition 112a.

The memory range “transfer not feasible” or “transfer failed” may be indicated to the hypervisor 128 by the MRD 134a if the comparison provides that the number of memory ranges (size of the required memory) that are desired to be transferred is higher than the number of available claimable memory ranges (size of the available claimable memory ranges) in the partition 112a or the they are comparable. An indication indicating that the memory ranges “transfer is feasible” may be indicated to the hypervisor 128 by the MRD 134a if the comparison provides that the partition 112a may not run into memory shortage due to the transfer of the memory ranges. Accordingly, identified memory ranges 120a and/or 116a may be transferred to the partition 112, resizing of the partitions 112a and 112 may be carried out to exclude and include the transferred memory ranges and the tracker 138 may be updated accordingly.

In some embodiments, above comparison may be carried out by the hypervisor 128. The hypervisor 128 may be arranged for tracking of the memory ranges 116, 116a, 120 and 120a using the tracker 138. The tracker 138 may maintain the register for tracking details that which memory ranges lie in which partition. The register may be updated as and when any memory range is transferred from one partition to another partition.

In some embodiments, the present subject matter may be implemented in a co-owned memory environment. In the co-owned memory environment one or more OS while initializing the memory, initialize the entire memory and maintains a register to identify the markups of the partitions. Each of the partitions may be owned or co-owned by multiple OS. The OS may identify one partition as owned partition and remaining partitions as co-owned partition.

One of the advantages of such environment is that it allows reducing time overheads substantially, particularly when memory ranges are required to be transferred from one partition to another. Since the OS has initialized entire memory therefore no additional step of addition or deletion of the memory is required. Once the OS obtains permission to use the memory ranges from the OS that owns the other memory ranges, those memory ranges are almost instantaneously made available to the OS. Further, in co-owned memory environment at least one step of acquiring details regarding available memory ranges for claiming may be reduced as the OS has already initialized the entire memory and therefore has the required information with respect to availability of the claimable memory ranges.

The present subject matter may be implemented in an environment where each of the partitions is isolated with respect to memory. Each of the partitions may belong to an OS. In such environments when an OS runs into shortage of memory it may then generate and issue a request for obtaining memory ranges to the hypervisor. Subject to availability of the memory ranges in other partitions the apparatus requires to perform a step of deletion and a step of addition of the memory ranges. These steps are often referred as OnLine Deletion (OLD) and OnLine Add (OLA). The step OLD is performed on the partition from where the memory ranges are going to be claimed to delete claimable memory ranges from the partition. The step OLA is performed on the partition, in which it has been desired to include the memory ranges.

In some embodiments, each partition or some partitions have two dummy zones. One each for co-owned memory ranges and memory ranges that may be ejected from the partition. The dummy zone for co-owned memory ranges may be for accepting memory ranges (say, acceptor zone) from other partitions, whereas other dummy zones may determine the memory ranges that can be donated (say, donor zone) by the partition. In some embodiments, the present subject matter is implemented in a single dummy zone of the co-owned memory. If the memory claiming process is called by a paging daemons' context then the function of the dummy zone is to request for getting memory. If the call is from the context of the inter-partition message, then the call is for giving away (donating) memory ranges. In an example, this embodiment may be useful for systems based on Hewlett Packard UniX (HP-UX®), where the memory ranges are mapped into system space for caching. For such systems, while populating zones it may be desirable to know properties, such as ejectability (available to be claim by other partitions) or non ejectability of the memory ranges against the mapped physical memory ranges.

Following depicts an example algorithm for memory range claiming.

```
Memory range claiming Algorithm for Acceptor Zone (..)
    Begin
        If (system can face memory pressure or system is greedy )
        Begin
            Refer the zone for co-owned memory ranges
            If (all the co-owned memory ranges have already
            been received)
            Then
            Memory range transfer failed
            Else
            Begin
                Send a request to transfer memory ranges
                via inter-partition message.
            End
        End
    End
Memory range claiming Algorithm for Donor Zone(..)
    Begin
        If(system can face memory pressure or system is greedy )
        Begin
        Refer the zone for Ejectable pages
        If (all the available memory ranges have already
        been transferred OR the system is under Memory
        pressure)
        then
        memory range transfer is failed.
        Else
        Repeat
            Find sufficient memory ranges to meet the
            request.
            If enough free memory ranges are found
            then
            Begin
                Initiate page-out on the mapped
                memory ranges
                Wait for memory ranges to become
                free
                Send a reply message to the partition
                that needs memory
                If the memory ranges are accepted
                then
                Mark the donated memory ranges as
                migrated.
            End
            Else
            Begin
                Initiate paging on ejectable and non-
                pinned memory ranges
            End
        Until gives up
    End
End
```

The above algorithm remains valid for some embodiments, where OLA and OLD operations are possible. The acceptor zone in such embodiments will not be used for deciding if inter-partition message is needed to transfer memory ranges. This is because the acceptor zone does not require prior information of the size of transferable memory that is available on other systems.

In operation, the memory shortage detector 122 detects for a memory shortage. The memory shortage detector 122 may detect such a shortage by detecting invocation of a memory claiming process for claiming memory ranges of the partition 112. The detection of such an invocation is passed on to the controller 124. The controller 124 takes this detection as an indication that the OS 126 is facing memory shortage and instantiates memory claiming process for claming memory ranges from other partitions 112a of the memory 110. The controller 124 may instantiate the memory claiming process by invoking the dummy zone controller 132. The MRR 136 of the dummy zone controller 124 requests the hypervisor 128 for seeking memory ranges. The hypervisor 128 passes instructions to the MRD 134a to obtain details of the memory ranges. The MRD 134a of the dummy zone controller 132a determines the possibility of memory range transfer, while doing so, the MRD 134a may also determine if allowing claiming of the memory ranges would cause any shortage of memory for its own OS 126a. The possibility of memory shortage due to transferring of memory ranges may be determined by the MRD 134a by comparing the size of available claimable memory ranges 116a/120a and the required size of the memory ranges by the OS 126. The MRD 134a may send a message to the MRR 136 via the hypervisor 128 that the memory range transfer is not possible or “failed” if the size of the memory required to be claimed by the OS 126 is larger or comparable with the size of the available claimable memory ranges in the partition 112a. The MRD 134a may send a message to the MRR 136 of the OS 126 via hypervisor 128 indicating that the transfer is possible, if the size comparison determines otherwise. The hypervisor 128 take the possible transaction the memory ranges on record using the tracker 138. Subsequently, resizing of the partitions 112 and 112a may be carried out to include/exclude the memory ranges.

The foregoing description uses example methods to describe the above described technique of managing memory. However, it should be noted that the steps explained below may not necessarily be required to be performed in the order in which they have been described herein.

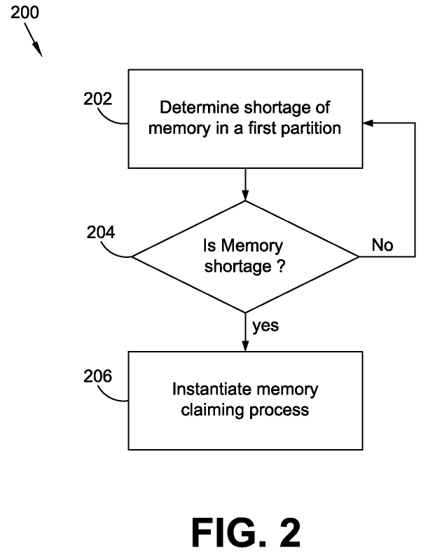

FIG. 2 shows a method 200 for managing memory according to an embodiment of the present subject matter. The method 200 may be implemented in an apparatus having an OS. According to the method 200, the memory includes following: one or more partitions; each of the partitions includes, one or more zones; and each of the zones includes, one or more memory ranges. At step 202, occurrence of memory shortage in a first partition of the memory during runtime may be determined. The step 202 may be performed by detecting invocation of memory claiming processing for claiming memory across zones of the first partition of the memory. At step 204, it may be checked if memory shortage is occurred. If not then step 202 may be repeated, else at step 206, a process for claiming memory from one or more zones of one or more partitions of the memory may be instantiated.

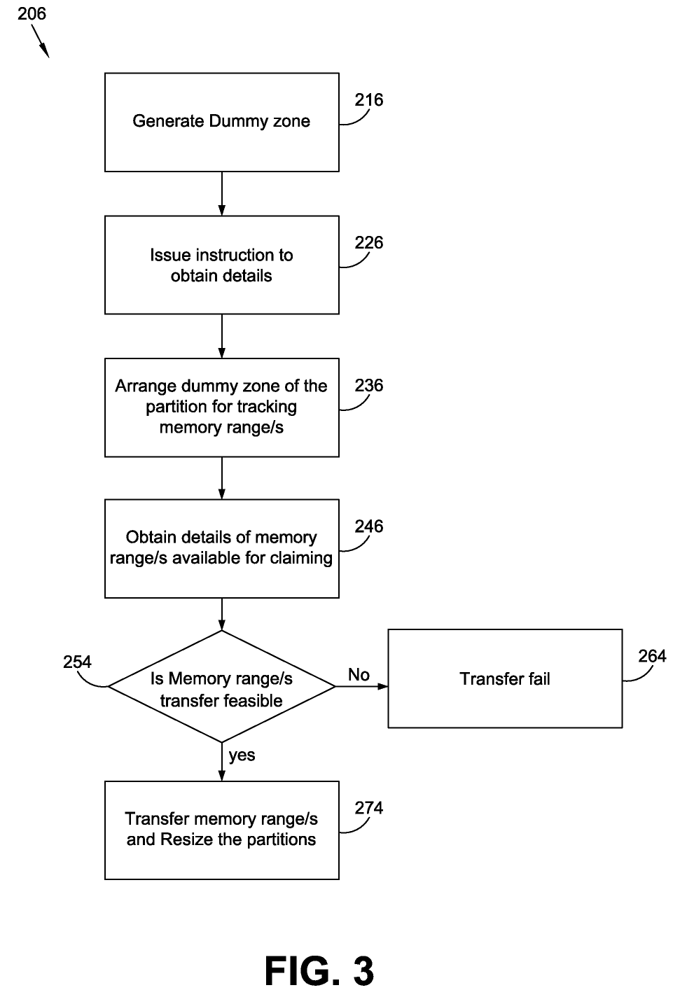

FIG. 3 shows in more detail the step 206 of instantiating invocation of memory claiming process according an embodiment of the present subject matter. According to this embodiment, at step 216, a dummy zone in each partition of the memory may be generated. The step 216 may be performed when the apparatus is being initialized by including unused memory ranges in the dummy zone or one or more partitions of the memory. The step 216 may also be initiated by a paging daemon for including unused memory ranges from other zones for generating or resizing the dummy zone. The step 216 may be performed using the paging daemon or the OS or the dummy zone controller or any combination thereof. Both the paging daemon and the dummy zone controller may be included in the OS.

At step 226, instructions to obtain details of the memory range/s available for claiming may be issued. The step 226 may be performed by the dummy zone controller, which may issue instruction to a hypervisor for obtaining desired details. At step 236, the dummy zone of the partitions may be arranged for tracking memory range/s of the partition that are/is ejectable from, and/or received by the partition of the memory. At step 246, details of the memory range/s that may be available for claiming in a partition or across the partitions may be obtained. This step may be performed by the dummy zone controller of the OS, which in turn obtains details of the memory range/s from the hypervisor.

At step 256, it may be determined, if the memory range/s transfer is feasible. The step 256 may be performed by detecting occurrence of memory shortage in a second partition of the memory due to the transferring of memory range/s from the second partition to the first partition. This shortage of memory range/s in the second partition may be determine by comparing size of claimable memory range/s and the size of the memory range/s that may be required by the claiming process. At step 264, the transfer failed message is sent if the result of the determination is false. At step 274, the memory range/s from the second partition to the first partition of the memory is/are transferred and resizing of the partitions of the memory is done to include or exclude the transferred memory ranges, if result of the determination is true.

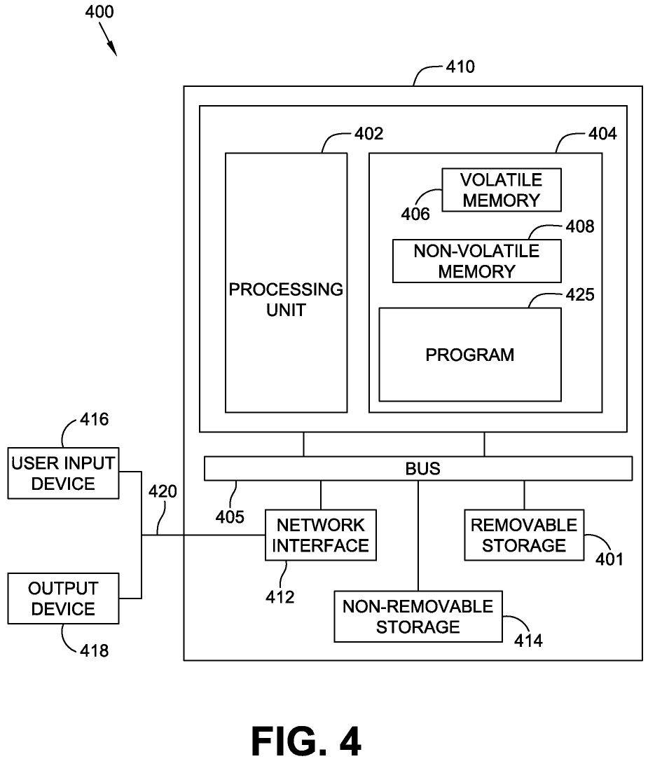

FIG. 4 shows an example of a suitable computing system environment 400 for implementing embodiments of the present subject matter. FIG. 4 and the following discussion are intended to provide a brief, general description of a suitable computing environment in which certain embodiments of the inventive concepts contained herein may be implemented.

A general computing device, in the form of a computer 410, may include a processor 402, memory 404, removable storage 401, and non-removable storage 414. Computer 410 additionally includes a bus 405 and a network interface 412.

Computer 410 may include or have access to a computing environment that includes one or more user input devices 416, one or more output devices 418, and one or more communication connections 420 such as a network interface card or a USB connection. The one or more output devices 418 can be a display device of computer, computer monitor, TV screen, plasma display, LCD display, display on a digitizer, display on an electronic tablet, and the like. The computer 410 may operate in a networked environment using the communication connection 420 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 404 may include volatile memory 406 and non-volatile memory 408. A variety of computer-readable media may be stored in and accessed from the memory elements of computer 410, such as volatile memory 406 and non-volatile memory 408, removable storage 401 and non-removable storage 414. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like; chemical storage; biological storage; and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 402 of the computer 410. For example, a program module 425 may include machine-readable instructions capable managing memory described above with reference to FIGS. 1-3. In one embodiment, the program module 425 may be included on a CD-ROM and loaded from the CD-ROM to a hard drive in non-volatile memory 408. The machine-readable instructions cause the computer 410 to encode according to the various embodiments of the present subject matter. The subject matter further teaches a computer readable medium that includes instructions for performing steps according to the present subject matter. The subject matter further provides an article that includes the computer readable medium according to present subject matter.

The method and apparatus has largely been described with reference to a hard partitioned system. However, the present subject matter may also be implemented (with appreciate changes such as excluding of the step of generating dummy zone in a partition that may be donating the memory range/s, etc.) in soft partition methods, for example, Xen, Integrity VM etc.

Amongst many advantages of the present subject matter one is that the method and apparatus of the present subject may not require any memory reservation and therefore are highly resource effective and may avoid under utilization of the memory. The responsiveness of the preset method and the apparatus is very high because the memory claiming process is instantiated almost automatically and dynamically. This offers advantages over unreliable approaches that require running commands or stubs (manually) which often result in thrashing of the OS. In addition the apparatus and the method of the present subject may be made to achieve extremely low overhead task by appropriate selection of algorithm.

The above description is intended to be illustrative, and not restrictive. Many other embodiments will be apparent to those skilled in the art. The scope of the subject matter should therefore be determined by the appended claims, along with the full scope of equivalents to which such claims are entitled. The present subject matter is advantageous in employing the garbage collector as a memory shortage detector and to instantiate invocation of memory claiming process for claiming memory across the partitions during runtime of the apparatus whenever the garbage collector is invoked.

As shown herein, the present subject matter can be implemented in a number of different embodiments, including various methods. Other embodiments will be readily apparent to those of ordinary skill in the art. The elements, algorithms, and sequence of operations can all be varied to suit particular requirements. The operations described-above with respect to the methods illustrated in FIG. 2 and FIG. 3 may be performed in a different order from those shown and described herein.

FIGS. 1-4 are merely representational and are not drawn to scale. Certain proportions thereof may be exaggerated, while others may be minimized, FIGS. 1-4 illustrate various embodiments of the subject matter that can be understood and appropriately carried out by those of ordinary skill in the art.

In the foregoing detailed description of the embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive invention lies in less than all features of a single disclosed embodiment. Thus, the following claims are hereby incorporated into the detailed description of the embodiments of the invention, with each claim standing on its own as a separate preferred embodiment.

1. A method for managing a memory of an apparatus, the memory includes one or more partitions, the method comprising the steps of:
detecting occurrence of memory shortage in a first partition of the memory during runtime of the apparatus; and
instantiating invocation of a memory claiming process for claiming memory from the one or more partitions according to an outcome of the detection.

2. The method as claimed in claim 1, wherein each of the one or more partitions includes one or more zones and detecting the occurrence of memory shortage comprises:
detecting invocation of memory claiming process for claiming memory across the one or more zones of the first partition.

3. The method as claimed in claim 1, wherein each of the one or more partitions includes one or more zones, each of the one or more zones includes one or more memory ranges and the method further comprises:
generating one or more dummy zones in each of the one or more partitions; and
arranging each of the one or more dummy zones of each of the one or more partitions for tracking the one or more memory ranges of the one or more partitions that are/is ejectable from, and/or received by, the one or more partitions of the memory.

4. The method as claimed in claim 3, wherein instantiating invocation of the memory claiming process comprises:
instructing to obtain details of the one or more memory ranges available for claiming;
obtaining details of the one or more memory ranges available across the partitions;
transferring the memory ranges from a second partition to the first partition of the memory according to the obtained details of the one or more memory ranges available for claiming; and
updating details of the one or more available claimable memory ranges in a tracker.

5. The method as claimed in claim 4, wherein transferring the one or more memory ranges comprises:
dynamically resizing of the one or more partitions to include or exclude the one or more transferred memory ranges.

6. The method as claimed in claim 5, wherein transferring the one or more memory ranges further comprises:
detecting occurrence of memory shortage in the second partition of the memory upon transferring the one or more memory range/s; and
performing the step of transferring according to the outcome of the detection.

7. The method as claimed in claim 1, wherein the one or more partitions are co-owned partitions.

8. An apparatus capable of managing a memory, the memory includes one or more partitions, the apparatus comprising:
a memory shortage detector for detecting occurrence of memory shortage in a first partition of the memory during runtime of the apparatus; and
a controller for instantiating invocation of a memory claiming process for claiming memory from the one or more partitions according to an outcome of detection.

9. The apparatus as claimed in claim 8, wherein each of the one or more partitions includes one or more zones, the memory shortage detector detects occurrence of memory shortage upon invocation of the memory claiming process for claiming memory across the one or more zones of the first partition.

10. The apparatus as claimed in claim 8, wherein each of the one or more partitions includes one or more zones, each of the one or more zones includes one or more memory ranges, the controller comprises:
a paging daemon, the paging daemon being configured to make the one or more memory ranges of the one or more zones of the one or more partitions available for claiming; and
a dummy zone controller, the dummy zone controller comprises:
a memory range receiver that receives, details of the one or more memory ranges available for claiming by the one or more partitions from a hypervisor and configured for claiming the one or more memory ranges; and
a memory range dispatcher that dispatches details of the one or more memory ranges that is claimable by the one or more partitions to the hypervisor.

11. The apparatus as claim in claim 10, wherein the apparatus is configured for generating a dummy zone in each the one or more partitions of the memory by initializing the one or more memory ranges available for claiming as part of the dummy zones.

12. The apparatus as claimed in claim 10, wherein the hypervisor includes a tracker for tracking details of the one or more claimable memory ranges of each of the one or more partitions.

13. The apparatus as claimed in claim 10, the dummy zone controller further instantiates transferring the one or more memory ranges from a second partition to the first partition of the memory and updating details of the one or more available claimable memory ranges in the tracker.

14. The apparatus as claimed in claim 8, wherein the dummy zone controller is configured for dynamically resizing of the one or more partitions to include or exclude transferred memory range/s in or from the one or more partitions.

15. The apparatus as claimed in claim 8, wherein the dummy zone controller instantiates detecting of occurrence of memory shortage in the second partition of the memory due to the transferring of the one or more memory ranges and transfers the one or more memory ranges according to the outcome of the detection.

16. The apparatus as claimed in claim 8, wherein the one or more partitions are co-owned partitions.

17. A computer system comprising:
a processing unit; and
a memory coupled to the processor, the memory having stored therein a code for performing steps of the method described in claims 1.

18. A computer-readable medium operable with a computer system, the computer-readable medium having stored thereon instructions operable with an architectural simulator environment supported by the computer system, the medium comprising: instructions for performing steps of the method as described in claim 1.

19. An article comprising a computer readable medium of claim 18.

20. An article comprising the apparatus according to claims 8.
